(19) United States
(12) Patent Application Publication
(10) Pub. No.: US 2026/0177799 A1
(43) Pub. Date: Jun. 25, 2026

(54) LIGHT SHEET IMAGING APPARATUS AND METHOD

(71) Applicant: NATIONAL UNIVERSITY OF SINGAPORE, Singapore (SG)

(72) Inventor: Nanguang CHEN, Singapore (SG)

(73) Assignee: National University of Singapore, Singapore (SG)

(21) Appl. No.: 19/124,181

(22) PCT Filed: Oct. 24, 2023
(86) PCT No.: PCT/SG2023/050711

§ 371 Date: Apr. 24, 2025

(30) Foreign Application Priority Data
Oct. 26, 2022 (SG) 10202251495V

(51) Int. Cl. G02B 21/00

(52) U.S. Cl. CPC G02B 21/0076; G02B 21/0032

(57) ABSTRACT

A laser speckle imaging apparatus 100 and method are provided herein. In an embodiment, the apparatus 100 for generating flow information of a biological sample 116 comprises an illumination optical device 115 operable to generate one or more illumination light sheets for selectively illuminating the biological sample 116 to produce corresponding scattered light; a first image acquisition device 135 operable to acquire the corresponding scattered light of each illuminated layer at a same wavelength as the illumination light sheet; and an image processing device 141 operable to construct 3-dimensional flow information of the biological sample 116 from speckle patterns of the acquired scattered light. An apparatus and method for imaging a biological sample using a specific scanning mirror and grating element is also discussed.

### TECHNICAL FIELD

This invention generally relates to a light sheet imaging apparatus and method, in particular, but not exclusively, for detecting 3D flow information of a biological sample.

### BACKGROUND

Laser speckle imaging (LSI) is one of the established flow imaging methods and is a label-free in vivo flow imaging modality based on analysis of dynamic fluctuations in laser speckle patterns. LSI has been broadly applied to visualize blood flow imaging in living tissues such as the retinal, skin, and brain since the imaging method was first introduced in the 1980s. LSI could be used to monitor dynamic blood flow response and relative changes in values. However, LSI is a wide-field imaging technique, which is generally limited to surface imaging (e.g. surface flow maps), as it does not provide depth selectivity and is essentially a 2D surface imaging technique. Further, blood flow velocity measurement using a conventional non-invasive and contact-free LSI system and method is relative or qualitative, not quantitative and are susceptible to artifacts/noises.

It is an object of the present invention to address problems of the prior art and/or to provide the public with a useful choice.

### SUMMARY

According to a first aspect of the present invention, a laser speckle imaging apparatus for generating flow information of a biological sample is provided. The apparatus comprises an illumination optical device operable to generate one or more illumination light sheets for selectively illuminating the biological sample to produce corresponding scattered light; a first image acquisition device operable to acquire the corresponding scattered light of each illuminated layer at a same wavelength as the illumination light sheet; and an image processing device operable to construct 3-dimensional flow information of the biological sample from speckle patterns of the acquired scattered light.

Using light sheet to illuminate the biological sample empowers the apparatus with an ability of optical sectioning to obtain high-quality 3D images of blood flow and vasculature in vivo, since the 3D flow in the biological sample could be visualised whether layer by layer or batch of layers by batch of layers. Therefore, the present apparatus is not limited to penetration depth limitation and surface detection of conventional LSI system, and broadens the application of this non-invasive imaging method.

In an embodiment, the illumination optical device may comprise a grating element operable to receive an incident light beam and split the incident light beam into at least two illumination light sheets for selectively illuminating the biological sample at the same time. It is envisaged that the grating element may be a transmission grating. The use of grating element may help to improve the speed of scanning.

In an embodiment, the illumination optical device may comprise a cylindrical lens arranged to generate the incident light beam.

In an embodiment, the incident light beam may include a plurality of incident sub-beams and the illumination optical device may comprise a cylindrical lens array (or a cylindrical micro-lens array) arranged to generate the plurality of incident sub-beams for the grating element to split each incident sub-beam into at least two illumination light sheets. With the capability of generating a plurality of incident sub-beams, the speed of scanning may be significantly improved.

In an embodiment, the illumination optical device may further comprise a rotatable scanning mirror operable to adjust an angular direction of the incident light beam to produce a reflected light beam and the incident light beam received by the grating element is the reflected light beam. It is envisaged that the rotatable scanning mirror may comprise a galvo mirror. As the rotatable scanning mirror may be rotated to adjust the angular direction of the incident light beam, this may help to significantly improve the scanning speed.

It is envisaged that the grating element may be so arranged that an angle between each illumination light sheet's optical axis and the acquired corresponding scattered light's optical axis may be between 0 degrees and 90 degrees, or between 30 degrees and 60 degrees. With this configuration of slanted light sheet, the scattered light acquired will be forward scattered light which may help to enhance the detected light signal. The stronger magnitude of the light signal may provide greater flexibility to configure the image acquisition speed and exposure time without worrying about the photon budget.

In an embodiment, the first image acquisition device may comprise an iris with an adjustable aperture for adjusting the scattered light. The adjustable iris may help to achieve a relatively uniform image resolution within the field of view defined by characteristics of the slanted light sheet.

In an embodiment, the illumination optical device may comprise a prism operable to transmit the one or more illumination light sheets to the biological sample. Using of the prism may help to minimize diffraction and aberrations of the illumination light sheet.

In an embodiment, the first image acquisition device may comprise an emission filter operable to allow desired fluorescence to pass through to the first image acquisition device. This configuration helps to extend the laser speckle imaging apparatus into an application of fluorescence imaging.

In an embodiment, the laser speckle imaging apparatus may comprise a transmission optical device operable to generate an transmission light beam for illuminating the biological sample, the transmission light beam having a different wavelength from the illumination light sheets; and a second image acquisition device operable to acquire the corresponding transmitted light of the biological sample at a same wavelength as the transmission light beam and generate transmission images, wherein the image processing device may be operable to adjust the constructed 3-dimensional flow information of the biological sample based on transmission images. This configuration may help to augment the laser speckle imaging apparatus, which may, inter alia, on the one hand lead to complimentary flow and vasculature information and on the other hand provide a cross-validation and calibration method for laser speckle imaging.

According to a second aspect of the present invention, a laser speckle imaging method is provided. The method comprises generating one or more illumination light sheets to selectively illuminate one or more layers of a biological sample to produce corresponding scattered light; acquiring the corresponding scattered light at a same wavelength as the illumination light sheet; and constructing 3-dimensional flow information of the biological sample from speckle patterns of the acquired scattered light. The method helps to ease the process of imaging 3D flow information of the biological sample at a fast speed but a low cost and without a limitation to imaging a surface of the biological sample. The simplicity of the method may help the operator to better monitor flow status of the biological sample.

It is envisaged that one illumination light sheet may be used for illuminating the biological sample at one time; and in this scenario, the biological sample may be illuminated layer by layer to produce the scattered light corresponding to each layer. It is also envisaged that two or more illumination light sheets may be used for illuminating the biological sample at a same time to form a batch of illuminated layers of the biological sample, and in this scenario, the scattered light produced may correspond to each layer of the batch.

In an embodiment, the method may comprise adjusting positions of the two or more illumination light sheets to produce another batch of the illuminated layers of the biological sample. It is further envisaged that the positions of the illuminated layers may be adjusted using a rotatable scanning mirror, such as a galvo mirror. The rotatable scanning mirror may help to improve the speed of scanning substantially.

In an embodiment, the method may comprise generating a transmission light beam for illuminating the biological sample to produce a transmitted light, the transmission light beam having a different wavelength from the illumination light sheets; acquiring the transmitted light at a same wavelength as the transmission light beam; and adjusting the constructed 3-dimensional flow information of the biological sample based on acquired transmitted light.

According to a third aspect of the present invention, there is provided a non-transitory computer-readable storage medium for storing a computer program, when executed by a processor, performs a laser speckle imaging method, which comprises generating one or more illumination light sheets to selectively illuminate one or more layers of a biological sample to produce corresponding scattered light; acquiring the corresponding scattered light at a same wavelength as the illumination light sheet; and constructing 3-dimensional flow information of the biological sample from speckle patterns of the acquired scattered light.

According to a fourth aspect of the present invention, there is provided an apparatus for imaging a biological sample. The apparatus may comprise an illumination optical device comprising a rotatable scanning mirror operable to adjust an angular direction of an incident light beam to produce a reflected light beam, and a grating element operable to split the reflected light beam into at least two illumination light sheets for selectively illuminating the biological sample at the same time to produce corresponding light; and an image acquisition device operable to acquire the corresponding light of each illuminated layer for imaging the biological sample. With the use of combination of the rotatable scanning mirror, the grating element and the light sheet illumination, the speed of scanning the biological sample is significantly improved. This can be applied to systems, such as the LSI system and fluorescence microscope, that require 3D scanning with high scanning speed.

In an embodiment, the apparatus may comprise an image processing device operable to construct 3-dimensional imaging information of the biological sample from contrasting patterns of the acquired corresponding light.

It is envisaged that the grating element may comprise a transmission grating. It is also envisaged that the rotatable scanning mirror may comprises a galvo mirror.

In an embodiment, the incident light beam may include a plurality of incident sub-beams and the illumination optical device may comprise a cylindrical lens array (or a cylindrical micro-lens array) arranged to generate the plurality of incident sub-beams for the grating element to split each incident sub-beam into at least two illumination light sheets.

In an embodiment, the illumination optical device may comprise a cylindrical lens arranged to generate the incident light beam.

In an embodiment, the image acquisition device may comprise an emission filter operable to filter the acquired corresponding light to allow desired fluorescence to pass through to the image acquisition device.

It is envisaged that the grating element may be so arranged that an angle between each illumination light sheet's optical axis and the acquired corresponding light's optical axis may be between 30 degrees and 60 degrees. More specifically, the angle may be at any value between 30 degrees and 60 degrees, and thus, the range may be between 25 degrees and 55 degrees, 20 degrees and 50 degrees etc.

In a fifth aspect, there is provided a method for imaging a biological sample, comprising: adjusting an angular direction of an incident light beam by a rotatable scanning mirror to produce a reflected light beam; and splitting the reflected light beam by a grating element into at least two illumination light sheets for selectively illuminating the biological sample at the same time to produce corresponding light; and acquiring the corresponding light of each illuminated layer for imaging the biological sample.

It would be apparent that features relating to one aspect may be applicable and used interchangeable with features relating to the other aspects.

### BRIEF DESCRIPTION OF THE DRAWINGS

FIG. 1 depicts a schematic diagram of a laser speckle imaging apparatus, according to a first embodiment of the present invention;

FIG. 2 depicts anisotropic scattering in a biological sample and detected signal intensity versus scattering angle, including angles used in FIG. 1;

FIG. 3 depicts a diagram illustrating main functional steps of a laser speckle imaging method performed by the apparatus of FIG. 1;

FIG. 4 depicts translation of a biological sample relative to illumination light sheet using the apparatus of FIG. 1;

FIG. 5 depicts a transmission image with slicing orientation of a 4-dpf zebrafish larva using the apparatus of FIG. 1;

FIGS. 6(a)-(d) depict four representative frames of 300 interpolated en-face images obtained from scan of FIG. 5;

FIG. 7 depicts an angiograph of a single slice of FIG. 5 with indications of four test points for analysis;

FIG. 8 depicts flow velocity waveforms detected at the four test points of FIG. 7;

FIG. 9 depicts a cross-sectional view of trunk structure of a 3-dpf zebrafish larva sliced by an illumination light sheet produced by the apparatus of FIG. 1 with the flow map superimposed on the morphology;

FIGS. 10(a)-(f) depict an exemplary raw laser speckle image obtained using the apparatus of FIG. 1, and processing results of the exemplary raw laser speckle image;

FIG. 11(a) depicts an exemplary light intensity signal picked from a pixel in the DA region of FIG. 10(a) using the apparatus of FIG. 1; FIG. 11(b) depicts a short-time power spectrum by a time-frequency analysis on FIG. 11(a); FIG. 11(c) depicts comparison of DA blood flow velocities obtained using LSH-LSI and PIV;

FIGS. 12(a)-(f) depict results of applying PIV analysis to both LSH-LSI scalar velocity maps and transmission images demonstrating capability of the apparatus of FIG. 1 in vector velocity mapping;

FIG. 13 depicts a laser speckle imaging apparatus according to a second embodiment of the present invention;

FIG. 14 depicts a scheme diagram of a light sheet imaging apparatus according to a third embodiment of the present invention;

FIG. 15 depicts a scheme diagram of another light sheet imaging apparatus according to a fourth embodiment of the present invention.

### DETAILED DESCRIPTION

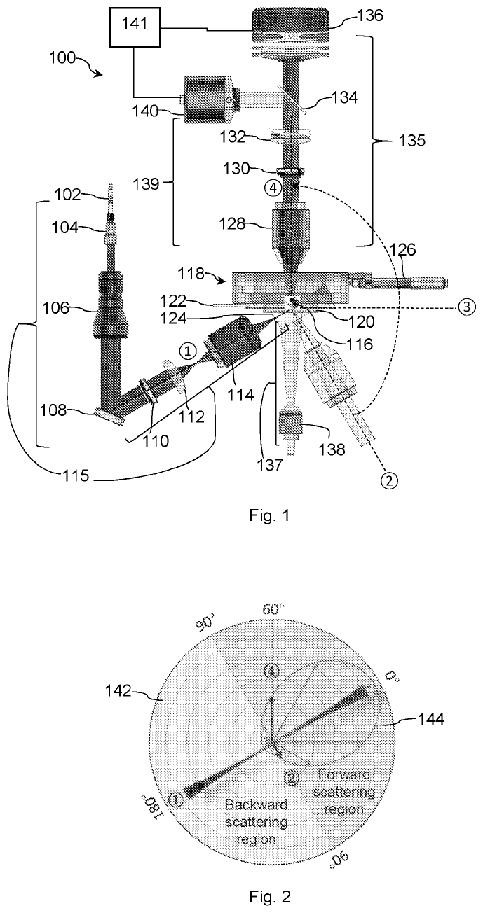

This disclosure provides a light sheet laser speckle imaging system (LSH-LSI). Specifically, FIG. 1 depicts a schematic diagram of a laser speckle imaging apparatus 100, according to a first embodiment of the present invention. The apparatus 100 generally comprises an illumination optical device 115 at an illumination light path, a sample stage 118, a first image acquisition device 135 at a detection light path, a computing device 141. For generating light, the illumination optical device 115 comprises a first light source 102 and in this embodiment, the first light source 102 is a laser diode 102 having an optical output at 640 nm in this embodiment, a collimator 104 configured to receive light from the laser diode 102 and to output a light beam. The illumination optical device 115 further comprises a beam expander 106 configured to receive the light beam and increase a diameter of the light beam collimated by the collimator 104 to a larger collimated output light beam as an incident light beam. The illumination optical device 115 further comprises a mirror 108, a first iris 110, a cylindrical lens 112 (f=50 mm in this embodiment) and an illumination objective lens 114. The mirror 108 is configured to adjust an angular direction of the incident light beam to produce a reflected light beam for the reflected light beam to pass through the first iris 110. The first iris 110 having an adjustable aperture is configured to control and adjust characteristics or parameters of the reflected light beam to effectively control and adjust parameters of the reflected light beam, such as thickness and length in the focal region of the reflected light beam. After passing through the adjustable aperture of the first iris 110, the reflected light beam controlled or adjusted by the first iris 110 passes through the cylindrical lens 112 and the illumination objective lens 114. The cylindrical lens 112 and the illumination objective lens 114 condenses the reflected light beam consecutively and output an illumination light sheet to illuminate a biological sample 116 (e.g. Zebrafish larva as shown in FIG. 1) placed on the stage 118.

The stage 118 comprises a standard glass-bottom dish 120 and a glass slide 122. The stage 118 is configured with a central mounting hole for mounting the standard glass-bottom dish 120. The glass slide 122 is configured to be mounted beneath the glass-bottom dish 120 with a small air gap between a bottom surface of the glass-bottom dish 120 and a top surface of the glass slide 122. The illumination optical device 115 further comprises a prism 124. The prism 124 is configured to attached to the glass slide 122 and positioned underneath the stage 118. The prism 124 is configured to minimize diffractions and aberrations of the illumination light sheet received from the illumination objective lens 114, and reduce wave front distortion along the illumination light path perpendicular to an optical axis \textcircled{1} of the illumination light sheet. The stage 118 further comprises an actuator 126, which can be digitally controlled via a data acquisition device or other appropriate means. The actuator 126 is configured to drive a motion of the stage 118 to shift the stage 118 left and right with micro-meter resolution for depth scanning. The biological sample 116 inside the dish 120 could be shifted or moved in a desired manner (e.g. desired direction/speed) together with the stage 118 by driven by the actuator 126. After the biological sample 116 is illuminated by the illumination light sheet, light scattered from the biological sample 116 is collected by the first image acquisition device 135.

The first image acquisition device 135 comprises a collection objective lens 128, a second iris 130, a tube lens 132 (f=100 mm in this embodiment), a dichroic mirror 134, and a first camera 136. The collection objective lens 128 is configured to collect and direct light scattered from the biological sample 116 to pass through the second iris 130. The second iris 130 having an adjustable aperture is configured to control and adjust characteristics or parameters of the scattered light collected by the collection objective lens 128. After passing through the adjustable aperture of the second iris 130, the scattered light is directed to pass through the tube lens 132 and the dichroic mirror 134 consecutively to be collected or received by the first camera 136. The first camera 136 in this embodiment is a high-speed scientific CMOS (sCOMS) camera (e.g. pco.dimax cs1, Excelitas TechnologiesR Corp™). The sCMOS camera 136 is able to capture raw speckle images at a full-frame (1296×1024 pixels) rate of up to 3,086 frames per second (fps) and could reach 10,782 fps for a moderate image size of 528×528 pixels. At the position shown in FIG. 1, the illumination light path is below the stage 118 and images are captured by the sCMOS camera 136 above the stage 118.

As can be seen from FIG. 1, an angle between the optical axis \textcircled{1} of the illumination light sheet and an optical axis \textcircled{4} of the scattered light received by the collection objective lens 128 is more than 90° (in other words, an angle between the direction of illumination light sheet and the direction of the collected scattered light is less than) 90°, in which case the scattered light is forward scattered light. As also shown in FIG. 1, the collection objective lens 128 may be arranged at a different position, such as with an optical axis of the scattered light at \textcircled{2} which is approximately orthogonal to the optical axis \textcircled{1} of the illumination light sheet, in which case the scattered light is backward scattered light. \textcircled{3} illustrates a slice orientation that the biological sample 116 can be imaged.

FIG. 2 depicts anisotropic scattering in biological samples and detected signal intensity versus scattering angle, including angles used in FIG. 1. Specifically, FIG. 2 illustrates angular distribution of scattering photon intensity. As shown in FIG. 2, where illumination light sheet is oriented at the direction of the optical axis \textcircled{1}, a density of collected scattered photon is affected by the angle between the optical axis \textcircled{1} and the optical axis of the scattered light received by the collection objective lens 128. The angular distribution can generally be divided into two areas, a backward scattering region 142 and a forward scattering region 144, as shown in FIG. 2. There are a plurality of concentric circles in FIG. 2, and the centre of the circles represent the biological sample 116. When the biological sample 116 is illuminated by an illumination light sheet from the direction of \textcircled{1}, scattered light may be detected from different directions, as depicted by the various arrows in FIG. 2. A length of each arrow demonstrate density of scattering photons in direction of that arrow. It can be seen that those arrows in the forward scattering region 144 are significantly longer than those in the backward scattering region 142. This demonstrates that, compared to backward scattering light detected in a confocal setup, the forward scattering light captured by the sCMOS camera 136 is of a stronger magnitude. As a result, there is great flexibility to configure the image acquisition speed and exposure time without worrying about the photon budget. As can be seen from FIG. 1, the illumination light sheet enters the biological sample 116 at a small angle (about) 30° relative to a horizontal surface of the stage 118 or the bottom surface of the glass-bottom dish 120 which are substantially horizontal, and the sCMOS camera 136 is oriented vertically. This is also shown in FIG. 2, wherein an angle between the optical axis \textcircled{1} of the illumination light sheet and the optical axis \textcircled{4} of the scattered light received by the collection objective lens 128 is approximately 120°, while an angle between the optical axis \textcircled{1} and the optical axis \textcircled{2} is approximately 90°.

As shown in FIG. 1, the laser speckle imaging apparatus 100 comprises a transmission optical device 137 and a second image acquisition device 139 for concurrent wide-field microscopic imaging. The transmission optical device 137 and the illumination optical device 115 share a common part, i.e. the transmission optical device 137 comprises the prism 124. The transmission optical device 137 further comprises a second light source 138 and in this embodiment, the first light source 138 is an LED 138. The laser diode 102 and the LED 138 have different wavelengths so that the scattered light from the laser diode 102 and the transmitted light from the LED 138 can be separated by the dichroic mirror 134 and detected by the sCMOS camera 136 and the CMOS camera 140 respectively. The second image acquisition device 139 is configured to capture wide-field transmission microscopic images. As shown in FIG. 1, the second image acquisition device 139 and the first image acquisition device 135 share some common parts, i.e. the second image acquisition device 139 comprises the collection objective lens 128, the second iris 130, the tube lens 132 and the dichroic mirror 134. Differently, the second image acquisition device 139 does not comprise the sCMOS camera 136 but instead comprises a second camera 140 (a general-purpose machine vision CMOS camera (e.g. UI-167 3060CP-M-GL Rev.2, IDS) in this embodiment). For obtaining a 2D image (or a 2D flow map), the stage 118 is adjusted to position the illumination light sheet in an appropriate region inside the biological sample 116. Instantaneous images captured by the sCMOS camera 136 and the CMOS camera 140 are configured to be displayed on a monitor (not shown in the drawings) for an operator to find regions of interest. In this embodiment, a green LED 138 with a centre wavelength of 520 nm is used for the wide-field illumination and the transmitted photons are collected by the collection objective lens 128. As shown in FIG. 1, the LED 138 is configured to illuminate the biological sample 116 from an angle different from the illumination light sheet output by the illumination objective lens 114. Optical axis of the transmission light beam generated by the LED 138 is substantially orthogonal to the surface of the stage 118. The collection objective lens 128 collects light from the biological sample 116, containing scattered photons come from the laser diode 102 and transmitted photons come from the LED 138. The dichroic mirror 134 transmits light for speckle imaging towards the sCMOS camera 136 but reflects light for wide-field microscopic imaging towards the CMOS camera 140. The wide-field transmission microscopic images could be engaged in particle image velocimetry (PIV) analysis, which on the one hand provides complimentary flow and vasculature information and on the other hand provides a cross-validation and calibration method for laser speckle imaging.

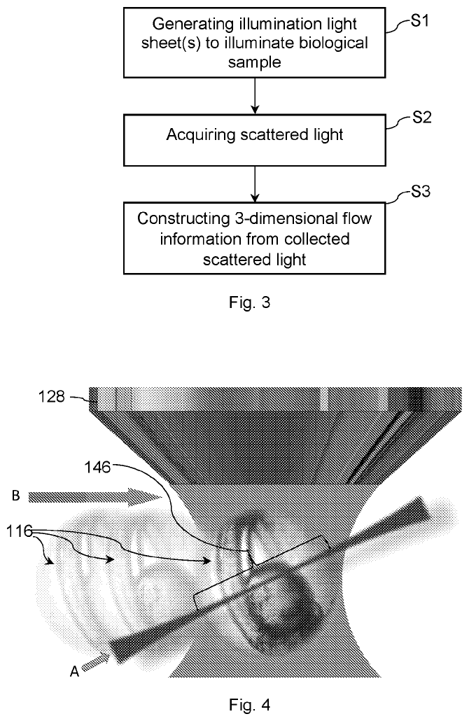

FIG. 3 depicts a diagram illustrating main functional steps of a laser speckle imaging method using the laser speckle imaging apparatus 100 depicted in FIG. 1. As depicted in FIG. 3, to use the laser speckle imaging apparatus 100 for laser speckle imaging, a first step (S1) is generating an illumination light sheet to selectively illuminate one or more layers of the biological sample 116 to produce corresponding scattered light. To do this, turn on the laser diode 102 to emit a laser beam, use the collimator 104, the beam expander 106, the first iris 110 and the cylindrical lens 112 to collimate, expand, adjust and condense the laser beam to generate one or more illumination light sheets. The one or more illumination light sheet is/are arranged to slice through the biological sample 116 in the dish 120 mounted on the stage 118 and selectively illuminates a thin layer of the biological sample 116. After the biological sample 116 is illuminated, light scattered from the biological sample 116. Therefore, a second step (S2) is acquiring the corresponding scattered light at a same wavelength as the illumination light sheet. To do this, the collection objective lens 128 collects the scattered light and direct the collected scattered light to pass through the second iris 130 and the tube lens 132 and to be eventually captured by the sCMOS camera 136 for imaging. The sCMOS camera 136 can be configured to acquire an image sequence with proper frame rate and exposure time. Motion of the stage 118 together with the biological sample 116 in the dish 120 mounted on the stage 118 can be driven by the actuator 126, including lateral shifting with respect to the stationary illumination light sheet. The lateral shifting of the stage 118 enables the illumination light sheet to illuminate the biological sample 116 layer by layer and the acquisition of a plurality of 2D images for 3D visualization. This can also be seen from FIG. 4. FIG. 4 depicts translation of the biological sample 116 relative to the illumination light sheet. As shown in FIG. 4, when the biological sample 116 is selectively illuminated by the illumination light sheet from direction of arrow A, part of the biological sample 116 is illuminated (i.e. the region 146 with a length of 453 μm indicated in FIG. 4) while the rest of the biological sample 116 remains unaffected. The collection objective lens 128 collects the scattered light from the selectively illuminated region. And the biological sample 116 can then be moved laterally (e.g. in direction of arrow B) for another region which was previously unaffected to be illuminated.

Typically, tens to a few hundred raw images may be obtained for speckle analysis at one location, the biological sample 116 is then shifted to another location to repeat the image acquisition process. After sufficient 2D images are captured, a third step (S3) is constructing 3D flow information of the biological sample 116 from speckle patterns of the collected scattered light based on the 2D images. The computing device 141, such as a personal computer, a server or any other device that is suitable for processing 2D images to generate 3D model or information may be used. The computing device 141 may be programmed to receive images from sCMOS camera 136 to construct 3D information manually or automatically. The images captured by the sCMOS camera 136 and the CMOS camera 140 may be transferred to the computing device 141 in and displayed on a monitor in real time for the operator to find regions of interest.

Afterward, the operator may adjust frame rate and exposure time of the sCMOS camera 136 to acquire raw image sequences. A raw image sequence is typically processed with an algorithm pixel by pixel to fit dynamic intensity fluctuations with a theoretical model. Consequently, the local fitted model parameter is converted to a flow velocity and assigned to the corresponding pixel. 3D sample scanning may be performed by laterally shifting the stage 118 (consequently the biological sample 116) with respect to the stationary illumination light sheet using the actuator 126 digitally controlled via a DAQ (data acquisition) device.

Further, as shown in FIG. 1, the apparatus 100 has a sub-system for concurrent wide-field microscopic imaging. The method may include generating a transmission light using the LED 138 to illuminate the biological sample 116 to produce a transmitted light; collecting the transmitted light at a same wavelength as the transmission light; and processing the transmission image derived from the transmission light, process the images as a comparison to adjust (e.g. validate, supplement and/or revise) the constructed 3-dimensional flow information of the biological sample 116.

For obtaining raw data (raw images), the apparatus 100 is configured accordingly. The wavelength of the laser, the thickness of the illumination light sheet, and the acquisition frame rate may be optimally configured for different biological samples 116. The thickness and length of the illumination light sheet can be calculated by equations (1) and (2) respectively:

$${w}_{0} = \frac{λ}{π N {A}_{IO}} \qquad ( 1 )$$

$${Z}_{R} = \frac{n {w}_{o}}{N {A}_{IO}} \qquad ( 2 )$$

where w₀ is Gaussian beam waist radius, λ is laser wavelength, NA_{IO} is the illumination objective lens numerical aperture, Z_{R} is Rayleigh range, and n is biological sample refractive index. The effective beam thickness is 2wₒ, while the effective beam length for even illumination is 2Z_{R}. A thicker illumination light sheet is associated with a lower axial resolution but a larger usable field of view, and vice versa. The thickness of the illumination light sheet also has a strong influence on the optical sectioning capability of the system and the accuracy of the blood velocity quantification. The light-sheet characteristics can be adjusted by changing size of the adjustable aperture of the first iris 110. The sCMOS camera 136 is used to collect raw laser speckle images and the CMOS camera 140 is used to collect wide-field transmission images. Both cameras are configured to be triggered by an NI DAQ data acquisition card for synchronized image acquisition in this embodiment, while the frame rates and exposure times can be set independently in the LabVIEW-based software designed for image acquisition and system control. For LSH-LSI imaging, the sCMOS frame rate determines the upper bound of the blood flow velocity that can be measured. As a consequence, faster blood flow often requires higher frame rates. On the other hand, an excessively high acquisition frame rate may be avoided as it put an unnecessary strain on the system resources and slow down the post processing process.

In traditional autocorrelation analysis, intensity autocorrelation function g₂(τ) is linked to the speckle decorrelation time (τ_{C}) using equation (3):

$${g}_{2} ( τ ) = 1 + β \vert {g}_{1} ( τ ) {\vert}^{2} = 1 + {β [ {e}^{- {( τ / {τ}_{C} )}^{n}} ]}^{2} \qquad ( 3 )$$

where g₂(τ) is the intensity autocorrelation function of time delay τ, g₁(τ) is corresponding field autocorrelation function, β is correction factor related to the measurement geometry, and n is another model parameter depending on the type of motion of light scatterers and the dynamic laser scattering regime. Usually, n takes values of 0.5, 1, and 2, corresponding to multiple scattering unordered motion (MU), multiple scattering order motion (MO) or single scattering unordered motion (SU), and single scattering ordered motion (SO) regimes, respectively. The fitted decorrelation time is consequently translated to a flow velocity V using equation (4):

$$𝒱 = \frac{λ}{π N {A}_{D O} {τ}_{C}} \qquad ( 4 )$$

where λ is the laser wavelength and NA_{DO} is effective numerical aperture of the collection objective lens 128.

The raw images captured by the sCOMS camera 136 contain inherent speckle patterns due to inferences between scattered photons of the same wavelength as the illumination light sheet. Statistical analysis performed on the speckle patterns can lead to parameters that are linked to the velocity of local microscopic scatterers. In this embodiment, laser speckle contrast analysis, temporal autocorrelation analysis, and time-frequency analysis are used to process the raw image sequence to generate the corresponding flow velocity maps.

In laser speckle contrast image analysis, the speckle contrast K is defined using equation (5):

$$K = \frac{σ}{〈 I 〉} \qquad ( 5 )$$

where σ is standard deviation and <I> is mean intensity. Both the standard deviation σ and the mean intensity <I> can be estimated spatially or temporally.

In the autocorrelation analysis, one can derive the intensity temporal autocorrelation function g₂(t, τ) at any time t using equation (6):

$${g}_{2} ( t , τ ) = \frac{{\int }_{t}^{t + Δ} {dt}^{′} I ( {t}^{′} ) I ( {t}^{′} + τ )}{{[ {\int }_{t}^{t + Δ} {dt}^{′} I ( {t}^{′} ) ]}^{2}} \qquad ( 6 )$$

where I is a speckle intensity, τ is a time lag, and Δ is a width of a time window for averaging.

Either the speckle contrast K or the autocorrelation function g₂(t, τ) can be used to estimate the instantaneous and local motion of scatters, and hence flow information. In traditional autocorrelation analysis, the intensity autocorrelation function g₂(τ) is linked to the speckle decorrelation time (τ_{c}) using equation (3) as described above.

To improve equation (3), a mixed theoretical model with two independently decay terms and one modulating term is adopted to calculate intensity autocorrelation g₂(τ) as equation (7):

$${g}_{2} ( τ ) = 1 + β ( {w}_{r} {e}^{- 2 τ / {τ}_{r}} + {w}_{f} {e}^{- 2 {τ}^{2} / {τ}_{f}^{2}} ) [ 1 + A cos t ( 2 π {f}_{0} τ ) ] \qquad ( 7 )$$

where the first exponential term wᵣe^{-2τ/τ}^{ᵣ} is associated with single scattering unordered motion (n=1) with a fitted weight wᵣ and a decorrelation time of τᵣ, while the second exponential term

$${w}_{f} {e}^{- 2 {τ}^{2} / {τ}_{f}^{2}}$$

corresponds to single scattering ordered motion (n=2) with another fitted weight w_{f} and another decorrelation time of τ_{f}; modulating term Acost(2πf₀τ) is associated with a frequency shift f₀ and a fitted parameter A. In case that the fitted parameter A is much smaller than 1, the fitted decorrelation time τ_{f} is consequently translated to a flow velocity v using equation (4), i.e.

$$v = \frac{λ}{π N {A}_{D 0} {τ}_{f}} .$$

Otherwise, the frequency shift f₀ is converted to the blood cell velocity V by equation (8):

$$v = \frac{λ {f}_{0}}{{n}_{t} cos θ} \qquad ( 8 )$$

where nₜ is a tissue refractive index and θ is an angle between illumination light sheet and flow direction (vessel orientation).

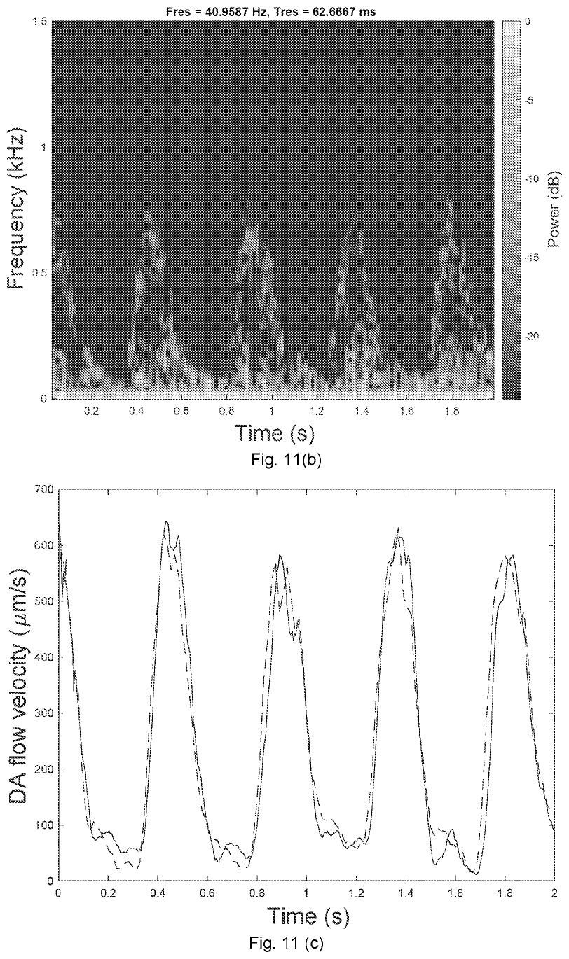

Besides temporal autocorrelation analysis (equation (6)), a time-frequency analysis method can be used to reliably estimate the local flow velocity and its spatial distributions. In this embodiment, the dynamic changes in light intensity is processed pixel by pixel in Matlab™ with a time-frequency analysis function “pspectrum” to compute short-time power spectrum estimates. For example, FIG. 11(b) shows the time-dependent power spectrum estimated from the time-series signal plotted in FIG. 11(a). The representative frequency shift f₀ at each time window is simply the maximum frequency at which the power spectrum density is beyond a threshold value estimated empirically from the system noise level. The local flow velocity is converted from the frequency shift using Equation (8).

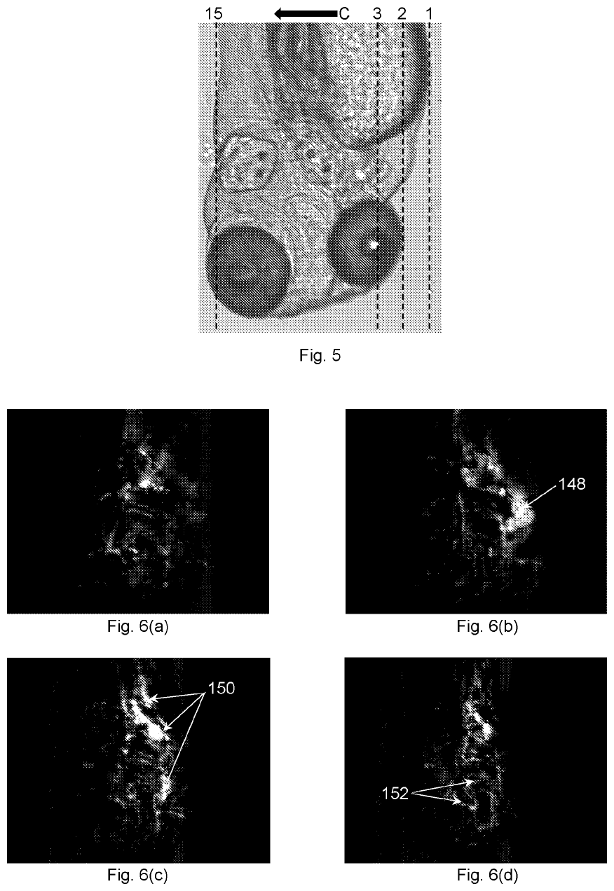

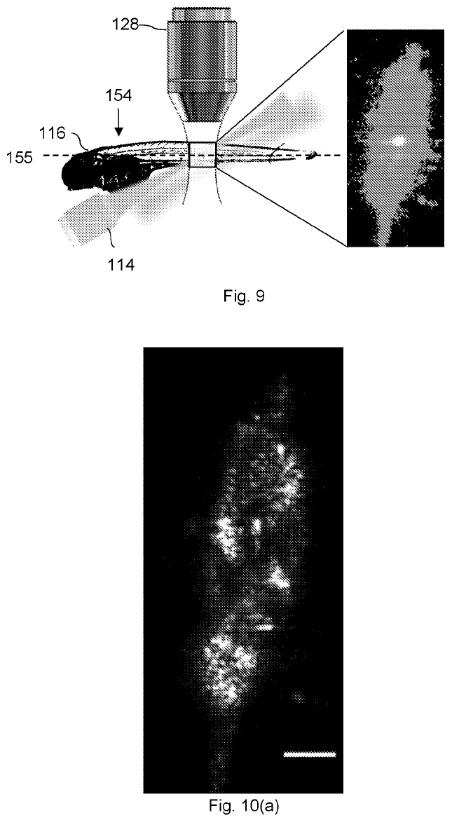

Specifically, for testing the laser speckle imaging apparatus 100, scanning experiment was performed on a 4 days post-fertilization (dpf) zebrafish larva in the head and trunk regions where the vascular system had a rather complex three-dimensional structure. FIG. 5 depicts a transmission image with slicing orientation of the 4-dpf zebrafish larva using the apparatus 100 of FIG. 1, with indication direction of shifting of the stage 118. During the scanning process for laser speckle image acquisition, head-tail central axis of the zebrafish larva is oriented to be perpendicular to an axis of the actuator 126 (see arrow 154 of FIG. 9). The dashed line 155 indicates where the illumination light sheet intersect with a focal plane of the first camera 136. The stage 118 (hence the zebrafish larva) was shifted step by step from left to right at a translational interval of 25 μm. Consequently, the illumination light sheet moved from right to left inside the animal (zebrafish) model. Its central location for each scanning step is indicated by one of the dashed lines (at a time) superimposed on the transmission image shown in FIG. 5, i.e. from No. 1 to No. 15 in direction of arrow C. Raw laser speckle images were acquired at 1,500 fps for two seconds for each of the 15 light sheet locations. In total, the image acquisition time was around 8 minutes inclusive of that for data transfer from camera memory to computer (264×476 pixels, 3000 frames for each step), stage translation, and stabilization. In this experiment, to focus on deriving the morphological information, a simple image processing method was used to reconstruct 15 β-maps to delineate the blood vasculature. These reconstructed 2D images were aligned and combined into a 3D image stack, with each slice mapped to a thin layer of the probed tissue volume. The normal distance between neighbouring slices was about 25 μm.

The raw images for each of the 15 light sheet slices are processed using the time frequency domain analysis method as described above and a blood flow image sequence for each slice is generated. Slice-by-slice angiographs are obtained by averaging the flow velocities over time. The angiographs were further processed using interpolation to generate a finer three-dimensional stack of 300 μm-face images. The depth interval was 1 μm, while the total depth range was 300 μm. FIGS. 6(a)-(d) depict four representative frames of the 300 interpolated en-face images. FIGS. 6(a)-(d) depict the images taken at a bottom layer, a lower middle layer, an upper middle layer, and a top layer, respectively. FIG. 6(b) shows that heart 148 is identified, FIG. 6(c) shows that big vessels 150 are identified while FIG. 6(d) shows that small vessels 152 are identified.

While the original image stack only consisted of 15 slices depicted in FIG. 5, the quality of 3D rendering appeared reasonably satisfactory. By scanning the same tissue volume with finer step size and reduced thickness of illumination light sheet, it would achieve an even better axial resolution that is closer to the lateral resolution.

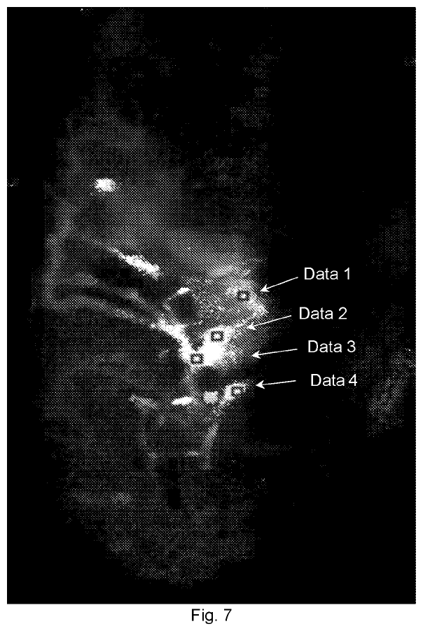

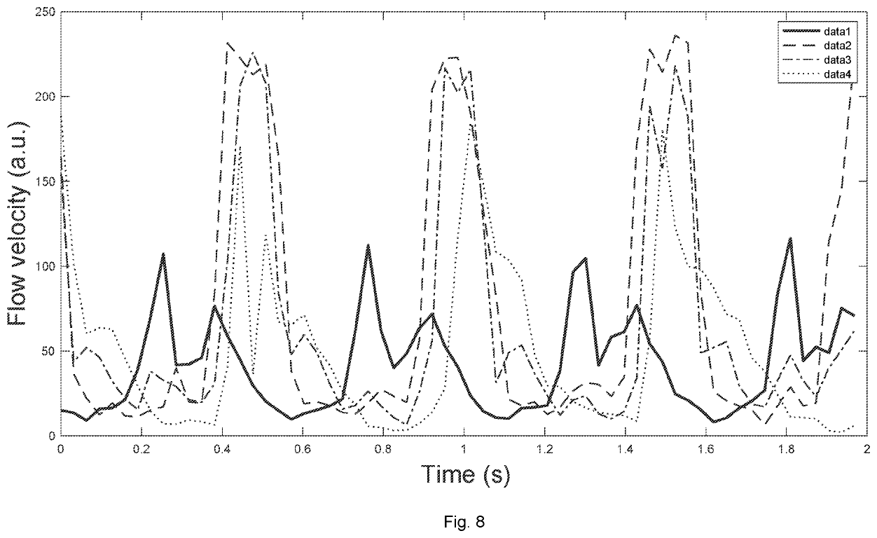

FIG. 7 depicts an angiograph of a single slice. Four test points in FIG. 7 are selected for estimating local blood flow velocity. The first test point is in the heart region and data for the first test point is referred to as Data 1. The second test point is in the dorsal aorta (DA) region and data for the second test point is referred to as Data 2. The third and fourth test points are in the region where downstream arteries reside, and data for the third and fourth test points are referred to as Data 3 and Data 4 respectively. FIG. 8 depicts flow velocity waveforms detected at the four tested points of FIG. 7. Data 1 is depicted in solid lines in FIG. 8. FIG. 8 shows that the flow velocity waveform of Data 1 has two peaks in each cardiac cycle. The first peak is associated with the inflow of blood cells during the diastolic phase while the second peak relates to the outflow in the contractile phase. Data 2 is depicted in dashed lines in FIG. 8, which shows fast-rising edge of the blood flow in the DA region that almost coincides with the peak outflow from the heart of Data 1. However, it reached much higher peak velocity values than Data 1. Data 3 is depicted in dot-dash lines in FIG. 8 and Data 4 is depicted in dotted lines in FIG. 8. Data 3 and Data 4 shows small time delays in the rising edge and the gradual decrease in the peak velocity. This demonstrates that the present invention is capable of providing quantitative measurement of flow velocity. As a comparison for illustration, PIV analysis is performed to trace the blood cells and generate flow maps.

Using the apparatus 100 depicted in FIG. 1, both laser speckle images and wide-field transmission images were acquired simultaneously from the trunk region of a 3-dpf zebrafish larva being used as the biological sample 116. FIG. 9 is an imaging geometry depicting the arrangement of the biological sample 116 with reference to the illumination light sheet. FIG. 9 depicts a cross-sectional view of the trunk structure sliced by the illumination light sheet, with the flow map superimposed on the morphology. As depicted in FIG. 9, the 3-dpf zebrafish larva was so positioned that the illumination light sheet intersected the trunk at an angle. Major blood vessels in the trunk, i.e., the DA and the posterior cardinal vein (PCV), were oriented horizontally to facilitate the acquisition of high-quality wide-field transmission images at 200 fps.

PIV analysis is performed on wide-field transmission images using PIVlab™, a GUI (graphic user interface) based Matlab™ program designed for particle image velocimetry, for mapping flow velocity. The procedures are as follows. Firstly, a transmission image stack is imported into PIVlab™. Secondly, one of the built-in algorithms is chosen for cross-correlation analysis. Usually, direct Fourier transform correlation with multiple passes and deforming windows (FFT window deformation) is preferred over single-pass direct cross-correlation (DCC) and Ensemble correlation. Thirdly, the selected analysis is configured and performed, after which the results are calibrated using a calibration image acquired separately. Eventually, the velocity distribution in the field of view and instant velocity waveforms in specific regions of interest are generated. Optionally, the blood vessel network can also be delineated by further processing the velocity maps.

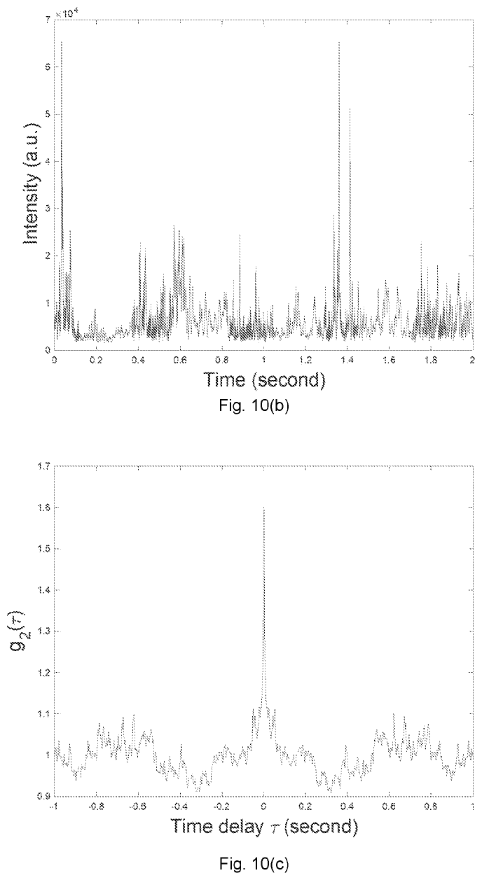

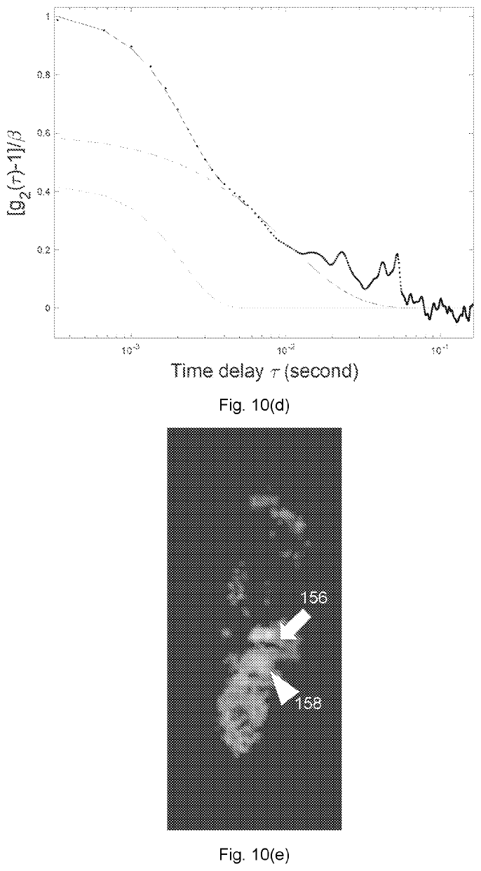

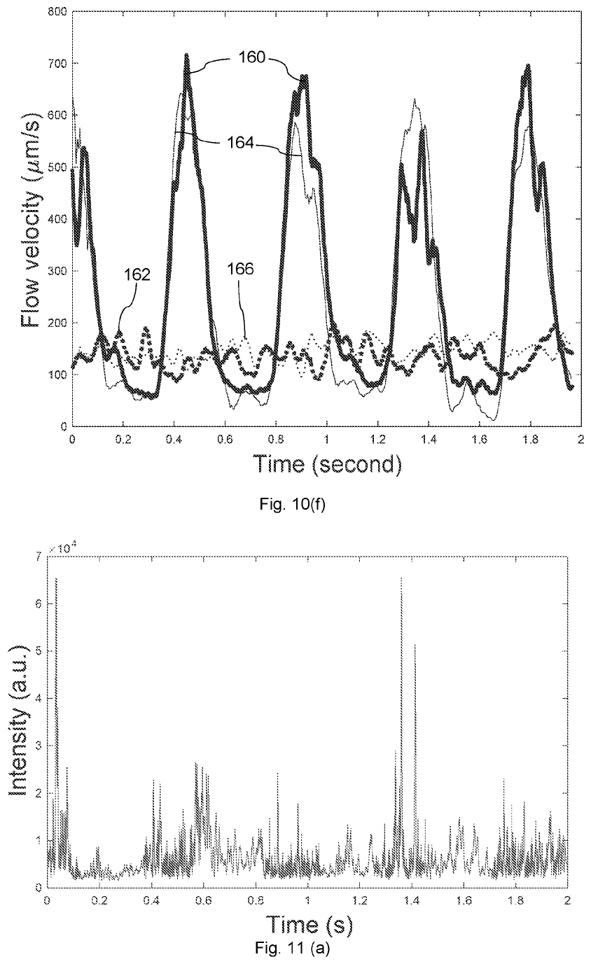

The raw laser speckle images were acquired at 3,000 fps, which led to a stack of 6,000 frames over 2 seconds. FIG. 10(a) is an exemplary raw laser speckle image (scale bar: 50 μm). Raw laser speckle images are cross-sectional intensity images in which rapid intensity fluctuations could be seen in big vessel regions. The high spatiotemporal resolution in the raw image stack provided important insight into complicated dynamic signal characteristics and is very beneficial in signal processing and interpretation. To find the time-averaged local flow velocity, temporal speckle signals are picked from the image stack pixel by pixel and the corresponding autocorrelation functions are calculated over the entire time window of 2 seconds. FIG. 10(b) is an exemplary light intensity signal (temporal speckle) picked from one pixel in the DA region of FIG. 10(a); and FIG. 10(c) depicts autocorrelation function of signal in FIG. 10(b). The results show that intensity autocorrelation g₂(τ) did not fit into a simple exponential model. The slow fluctuation patterns suggested deterministic correlations over long time scales, which were caused by periodic intensity changes in the scattered light from blood cells discretely arriving at the cross-section. FIG. 10(d) depicts a smaller delay time window of a result of model fitting FIG. 10(c). In the smaller delay time window (FIG. 10(d)), two different exponential decay patterns are visible in the experimental data (dots) and the curve can be best fitted, by applying equation (7) with the modulating term being zero (or with the parameter A being close to zero), the intensity autocorrelation g₂(τ) is calculated as g₂(τ)=1+β(0.602e^{-2τ/0.0206}+0.426e^{-2τ}^{²}^{/0.00366}^{²}). Here the first exponential term (dashed lines in FIG. 10(d)) corresponds to single scattering unordered motion (n=1) with a relatively long decorrelation time of 20.6 milliseconds and wᵣ having a value of 0.602. It is associated with the slow background random motion of blood cells as well as the entire animal at an effective velocity of 39.7 μm/s. The second exponential term (solid line in FIG. 10(d)) is linked to single scattering ordered motion (n=2) with a much smaller decorrelation time of 3.66 milliseconds and w_{f} having a value of 0.426, translating to a flow velocity of 223 μm/s. FIG. 10(e) depicts a velocity map derived from fitted parameters. The white arrow 156 indicates the DA region with higher flow velocity and the white triangle 158 points to the PCV region with relatively lower flow velocity. To quantify the dynamic blood flow, a much shorter time window was used for the decorrelation time estimation and the quantified time-dependent velocities were plotted in FIG. 10(f). FIG. 10(f) depicts a short window of flow velocity at DA and PCV regions analysed by LSI and PIV analysis. As shown in FIG. 10(f), velocities in both the DA and PCV were in good agreement between the LSI results the PIV results. The above analysis was based on the entire time window of 2 seconds and yielded the time-averaged flow measurements. The arterial flow velocity 160 of LSI results swung between extreme values during each cardiac cycle. The peaks were roughly 10 times higher than the valleys. On the other hand, the venous flow 162 of LSI results appeared to be much more continuous. The average (over 2 seconds) flow velocity estimated with LSH-LSI was 135.2 μm/s in the PCV and 259.8 μm/s in the DA. In comparison, the PIV analysis resulted in a mean velocity of 145.6 μm/s for the venous flow and 254.4 μm/s for the arterial flow. The waveforms of PIV velocities in DA 164 and PIV velocities in PCV 166 are also depicted in FIG. 10(f). As can be seen from FIG. 10(f), the LSI and PIV results closely match each other. The arterial blood flow, for example, had very similar dynamic characteristics in terms of peak value, valley value, pulse width, and rising and falling edges. Based on a statistical analysis of the five pulses, the peak arterial flow velocity was 636.9±79.6 μm/s (LSI) or 612.4±30.9 μm/s (PIV).

FIGS. 11(a)-(c) depict the time-frequency analysis procedure. FIG. 11(a) depicts the same light intensity signal as shown in FIG. 10(b). FIG. 10(b) shows that the intensity fluctuated in a seemingly random manner. However, there was a periodic pattern in the instantaneous oscillation frequency. FIG. 11(b) depicts a short-time power spectrum by a time-frequency analysis which confirms the periodicity. The frequency shifts were caused by the interference between detected light waves scattered from stationary tissues (e.g., vessel wall) and moving red blood cells. They can be readily converted to the local and instantaneous flow velocities. The representative frequency shift f₀ at each time window is simply the maximum frequency at which the power spectrum density is higher than a threshold value estimated empirically from the system noise level. The local flow velocity is converted from the frequency shift by Equation (8). The quantification accuracy of this simple frequency-domain analysis method was validated by comparing the LSH-LSI and transmission PIV results. FIG. 11(c) depicts comparison of DA blood flow velocities obtained between that from LSH-LSI and PIV, which reflects the highly pulsatile arterial (DA) blood flow waveforms. As shown in FIG. 11(c), similar to that shown in FIG. 10(f), LSH-LSI (dashed lines) and PIV (solid line) results have very similar dynamic characteristics in terms of peak value, valley value, pulse width, and rising and falling edges. Based on a statistical analysis of the five pulses, the peak arterial flow velocity was estimated at 595.7±23.1 μm/s (LSH-LSI) or 612.4±30.9 μm/s (PIV). Averaging over the 2-second time window, the flow velocity was 254.3 μm/s (LSH-LSI) or 254.4 μm/s (PIV) in the DA. The present invention has demonstrate the good capability of quantitatively measuring dynamic flow velocity.

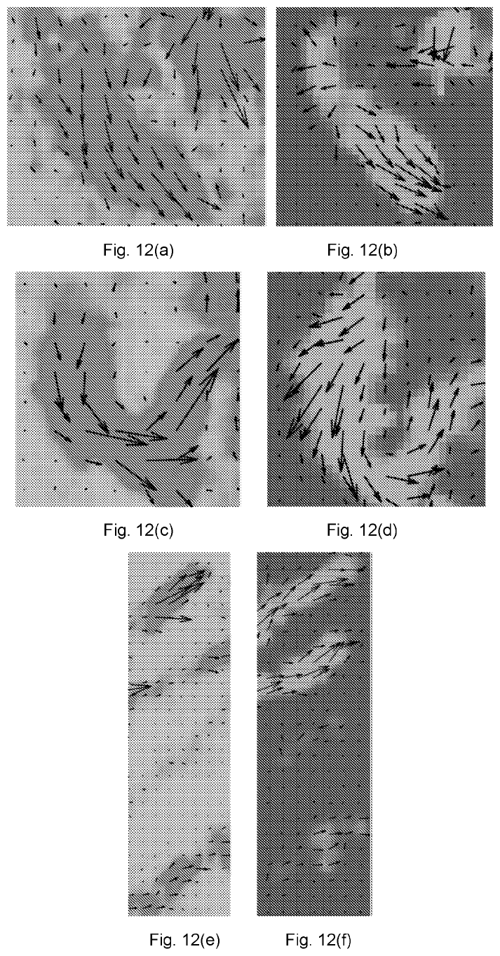

Experimental imaging data were collected from a 5-dpf zebrafish larva and the blood flow around the heart region was analysed to demonstrate the capability of the LSH-LSI system in vector velocity mapping. LSH-LSI scalar velocity maps and transmission images were obtained, including heart region, bulbous arteriosus region, and branchial arches region. PIV analysis was applied to both LSH-LSI scalar velocity maps and transmission images to generate corresponding vector flow velocity maps in the three regions, which were paired and compared in FIGS. 12(a)-(f). FIGS. 12(a), (c) and (e) depict laser speckle vector velocity maps, and FIGS. 12(b), (d) and (f) depict transmission velocity maps respectively. FIGS. 12(a) and (b) are for the heart region, FIGS. 12(c) and (d) are for the bulbous arteriosus region and FIGS. 12(e) and (f) are for the branchial arches region. FIGS. 12(a)-(f) show that the velocity magnitudes and directions derived from both imaging modalities were largely consistent.

Various advantages of the present invention can be appreciated from the foregoing description. With the novel optical design, system optimization and appropriate flow quantification algorithms, the present invention has, as shown above, the capabilities of three-dimensional imaging, dynamic flow velocity quantification, and vector flow mapping, with optimal 3D microcirculation imaging, high spatial and temporal resolution, fast imaging rate, and accurate quantitative flow velocity assessment. It is a simple but robust and quantitative means for measuring 3D visualization of micro-vessels and blood flow characteristics.

With transparent and translucent biological samples, the apparatus 100 takes advantage of the inherent optical sectioning capability of selected plane illumination to achieve tomographic, in vivo, and three-dimensional imaging of vascular structures and blood flow velocity distributions with high spatiotemporal resolution. The abovementioned Zebrafish larva imaging experiments performed with apparatus 100 have revealed complicated laser speckle dynamic characteristics, and the above proposed models helps to accurately retrieve the decorrelation time linked to flow velocity.

With the use of one or more illumination light sheets to selectively illuminate a sample region in which the flow information will be collected, the selected plane illumination achieves optical sectioning and make it possible to visualize the 3D flow in a sample layer by layer, or where necessary layers by layers. With the configuration of light sheet illumination, the apparatus achieves optical sectioning, even when without spatial filtering (as in confocal microscopy) or numerical post-processing (as in structured illumination microscopy). Unlike fluorescence light sheet microscopy, LSH-LSI is based on an intrinsic contrast mechanism (light scattering) and is a label-free imaging platform. LSH-LSI provides an excellent solution for investigating fluid dynamics (e.g. blood flow) in sophisticated 3D networks.

The configuration of the illumination light sheet being slanted with respect to a normal direction of the surface of the stage 118, or in other words, an angle between direction of the illumination light sheet and direction of the scattered light is preferably more than 0 degrees and less than 90 degrees (more preferably in the range from 30 degrees to 60 degrees), enhances the detected signal. Compared with the backscattering light in a confocal setup, the forward-scattering signal captured in LSH-LSI with the slant orientation is stronger by many orders of magnitude. This provides flexibility to configure the image acquisition speed and exposure time without worrying about the photon budget. In the abovementioned imaging experiments, the camera exposure time could be set to as low as a few microseconds (e.g. 5 μs) while the illumination light power was less than 10 mW. The high-speed imaging capability is desirable for enhanced dynamic range in flow velocity measurement. However, this is not its only benefit. It also enables fast data acquisition and can reduce the time for determining a local flow velocity to less than 1 millisecond. In comparison, in PIV-based methods, the traced particles need to move for a significant distance between image frames so that the flow velocity can be accurately estimated. Consequently, transmission images are typically captured at a much lower speed. A short acquisition time for individual slices is highly desired to improve the overall throughput especially in 3D mapping. Furthermore, the high imaging speed for LSH-LSI makes it possible to obtain local flow directions from instantaneous scalar velocity maps that are not averaged out over time. This has been demonstrated above that LSH-LSI is able to generate vector velocity maps based on additional processing of scalar laser speckle velocimetry results acquired at high frame rates. The extended functionality of LSH-LSI to determine local flow direction is especially useful in investigating fluid dynamics in the heart region, where the motion of blood cells is not confined in a one-dimensional small vessel.

Reconstruction of 3D angiograph helps to recover morphological information due to that the initially estimated velocities were relative instead of absolute. The strong optical sectioning capability of the present invention and proper separation of single scattered photons from multiply scattered photons as describe above also enable quantitative measurement of local flow velocity. With the use of a high-speed camera that captures the scattered light (at the same wavelength as the illumination light) from the sample, the high-speed camera allows fast acquisition of a raw image sequence, from which quantitative flow information can be retrieved. The angle between the illumination and detection axes balances the detection of forward scattering photons, which are far stronger than back scattering photons, with the depth of focus for wide-field image acquisition. Detection sensitivity and selectivity of the present invention are improved. Therefore, the present invention overcomes the disadvantages of conventional LSI methods which can only provide qualitative results to indicate relative changes, the accurate measurement would be very helpful for experimental and computational fluid dynamic analysis, in particular as a non-invasive contact-free method.

The photons detected by the sCMOS camera 136 are subjected to single scattering events with a relatively small scattering angle of around 60 degrees. As described above, for biological tissues, the scattering of visible light is dominated by forward scattering. Therefore, configuring the detection light path to be vertical on top of the stage 118 (as shown in FIG. 1) may help in capturing more scattering photons which may improve image quality and image acquisition speed, as under this configuration the scattered light is forward scattered light. Therefore, most single scatted photons propagate along directions close to the illumination optical axis, i.e. close to the direction of 0° illustrated in FIG. 2. This shows that light scattering in biological soft tissues is usually dominated by forward scattering that favours small scattering angles.

For example, the typical size of red blood cells is around 10 μm and for an incident beam at 640 nm, the anisotropic factor (the average cosine of scattering angle) is estimated at around 0.95. However, if the angle between the scattered photons and the direction of 0° is too small, the illuminated sample plane may not match the depth of focus for the detection optics. In this embodiment, the optical axis \textcircled{4} is configured at about 60° so that both the magnitude of the scattered light collected by the collection objective lens 128 and the depth of focus for the detection optics are taken into consideration. This angle can be arranged by taking into consideration of different factors, such as the parameters of the optics of the apparatus 100, the nature of the biological sample. For example, for applications in mouse brain and chick embryos imaging, the illumination and detection optics can be arranged on the same side of the stage 118, such as the illumination optics having the optical axis \textcircled{1} and the detection optics having the optical axis \textcircled{2} as depicted in FIG. 1. In view of the above, the angle between the optical axis of the illumination light sheet and the optical axis of the collected scattered light preferably varies within a range from 45° to 135°.

Due to various uncertainties, model fitting has been a tricky process in LSI. The described embodiment and the abovementioned investigation reveal the complicated nature of dynamic scattering signals, which requires delicate non-traditional theoretical modelling/treatment. The LSH-LSI system provided in the present invention is an excellent platform for researchers to further advance the basic theory as well as instrumentation design for quantitative laser speckle imaging. The system is augmented by the integration of transmission imaging subsystem, which provides an in vivo, independent cross-validation and calibration means.

The time-frequency analysis method presented above leads to a robust imaging processing algorithm for quantifying local flow velocities. It is especially suitable for microcirculation imaging as blood cells are moving in close proximity to micro-vessels. Consequently, the Doppler signals become adequately strong for accurate frequency shift estimation.

In short, the LSH-LSI described in the present embodiment is a label-free, three-dimensional, quantitative, and high spatiotemporal resolution blood flow imaging tool, addressing the limitation of existing imaging methods that either require fluorescence labelling/tracer particle seeding or are limited by two-dimensional image acquisition.

While FIG. 1 depicts the laser speckle imaging apparatus 100 as the first embodiment of the present invention, it is envisaged that the LSH-LSI system of the present invention may be configured and implemented in different manners.

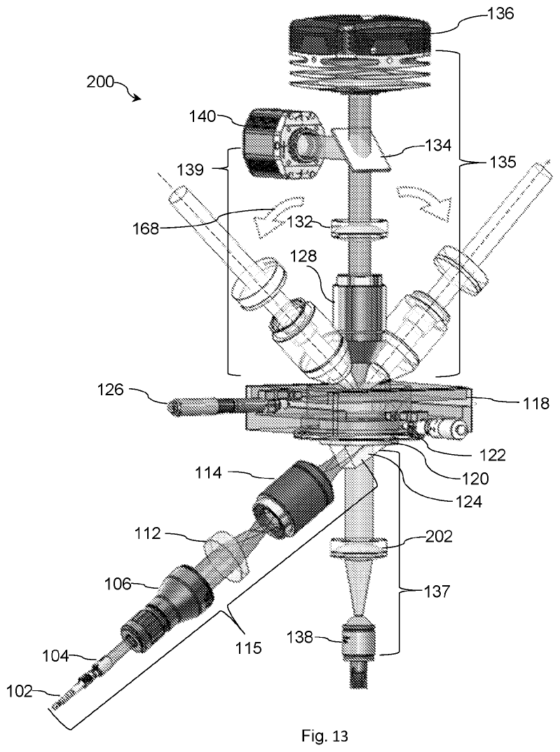

FIG. 13 depicts a laser speckle imaging apparatus 200 according to a second embodiment of the present invention. As most of the devices used in the second embodiment are the same as those in the first embodiment, they are labelled with the same reference numerals. Reference may be made to the above description where elements, devices, configurations and/or functions are not described in this embodiment. Following the light path, the first difference is that the illumination optical device 115 does not comprise the mirror 108 and the first iris 110 of FIG. 1 in this embodiment, so that the incident light beam output by the beam expander 106 is directed to pass through the cylindrical lens 112. As shown in FIG. 13, the beam expander 106, the cylindrical lens 112 and the illumination objective lens 114 are coaxial. Another difference is that, first image acquisition device 135 does not comprise the second iris 130 of FIG. 1, so that the collection objective lens 128 directs the scattered light to pass through the tube lens 132 directly. A further difference is that the transmission optical device 137 further comprises a tube lens 202. The transmission light from the LED 138 passes through the tube lens 202 before reaching the prism 124. Same as FIG. 1, FIG. 13 also shows that the optical axis of the collection objective lens 128 is vertical, i.e. orthogonal to a top surface of the stage 118 which is substantially horizontal. Besides, FIG. 13 also shows two alternative positions of the first image acquisition device 135, which are about 45° with respect to the top surface of the stage 118.

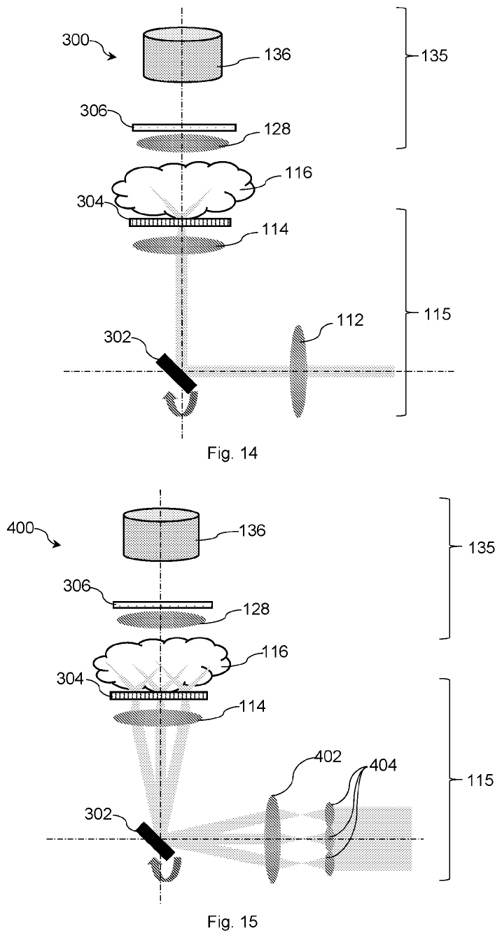

FIG. 14 depicts a scheme diagram of a light sheet imaging apparatus 300 according to a third embodiment of the present invention. Same as the second embodiment, the devices this third embodiment that are the same as those in the first embodiment are labelled with the same reference numerals. Reference may be made to the above description where elements, devices, configurations and/or functions are not described in this embodiment. As shown in FIG. 14, same as the first embodiment, the illumination optical device 115 comprises the cylindrical lens 112 in the illumination light path and the illumination objective lens 114, and the illumination optical device 115 is operable to generate a light sheet for illumination. The illumination optical device 115 further comprises a rotatable scanning mirror 302 which in this embodiment is a galvo mirror 302, and a grating element 304 which in this embodiment is a transmission grating 304. The incident light beam after passing through the cylindrical lens 112 (condensed in the direction perpendicular to the paper) is reflected by the galvo mirror 302. When the galvo mirror 302 is driven to rotate back and forth, the reflected light beam after the galvo scanner is tilted with a time-dependent angle with respect to the detection optical axis of the collection objective lens 128. The illumination objective lens 114 further condenses the reflected light beam in horizontal direction which can be shifted left and right to cover a region of interest of the biological sample 116. The transmission grating 304 is positioned above the illumination objective lens 114 and below the biological sample 116 as shown in FIG. 14. The incident light beam is diffracted by the transmission grating 304 to form two tilted illumination light sheets inside the biological sample 116. The tilting angle with respect to the detection optical axis of the collection objective lens 128 depends on light wavelength and grating groove spacing. A typical range of the tilting angle is 30 to 60 degrees. During the scanning process, the operator may move both tilted illumination light sheets from left to right (or in the opposite direction) at high speed afforded by the galvo mirror 302. Optionally, the first image acquisition device 135 further comprises a filter 306 which in this embodiment is an emission filter 306. The emission filter 306 can be included in the detection light path after the collection objective lens 128 for fluorescence microscopic imaging. For label-free, scattering based imaging, the emission filter 306 may be removed.

The grating based approach in the third embodiment helps to improve image acquisition speed, as compared to the first and second embodiments, for which the biological sample 116 is scanned by shifting the stage 118 with the actuator 126.

FIG. 15 depicts a scheme diagram of a light sheet imaging apparatus 400 according to a fourth embodiment of the present invention. A majority part of the fourth embodiment is the same as the third embodiment, except that the illumination optical device 115 does not comprise the cylindrical lens 112 of FIG. 14 but instead comprises a spherical lens 402 and a lens array 404 which in this embodiment is a cylindrical micro-lens array 404. The spherical lens 402 and the cylindrical micro-lens array 404 are operable to modulate light. The cylindrical micro-lens array 404 is operable to divide an incident light beam into two or more incident sub-beams. The spherical lens 402 receives and directs the two or more incident sub-beams to the rotatable scanning mirror 302. The rotatable scanning mirror 302 reflects the one or more incident sub-beams to the illumination objective lens 114 for the illumination objective lens 114 to receive the two or more incident sub-beams laterally at distance (Δ). Where there are more than two incident sub-beams, the distance (Δ) between any two neighbouring incident sub-beams received by the illumination objective lens 114 are the same. The illumination objective lens 114 condenses each incident sub-beam in horizontal direction which can be shifted left and right to cover a region of interest of the biological sample 116.

Consequently, the scanning range of the galvo mirror 302 is reduced to only cover the small distance Δ, which can be one or two magnitudes smaller than the length of the entire field of view. The implementation of the fourth embodiment is especially suitable for relatively thin samples and help to further improve the imaging speed comparing to the third embodiment. The grating and lens array based approach in the fourth embodiment helps to further improve image acquisition speed, as compared to the third embodiment, for which the biological sample 116 is scanned batch of layers by batch of layers, each batch comprising a plurality of layers.

While it is described in the first embodiment that the illumination optical device 115 comprises the laser diode 102, the collimator 104, the beam expander 106, the mirror 108, the first iris 110, the cylindrical lens 112, the illumination objective lens 114 and the prism 124, it is envisaged that the illumination optical device 115 may have different configurations in different embodiments as long as it is capable of generating illumination light sheet as required, for example, it may not comprise the mirror 108 and the first iris 110 as shown in FIG. 13, it may comprise different devices for different configuration, for example: in the third embodiment depicted in FIG. 14, it may comprise a light source (not shown in FIG. 14), the cylindrical lens 112, the galvo mirror 302, the illumination objective lens 114 and the grating element 304; in the fourth embodiment depicted in FIG. 15, it may comprise a light source (not shown in FIG. 15), the cylindrical micro-lens array 404, the spherical lens 402, the galvo mirror 302, the illumination objective lens 114 and the grating element 304.

While it is described in the first embodiment that the first image acquisition device 135 comprises the collection objective lens 128, the second iris 130, the tube lens 132, the dichroic mirror 134 and the first camera 136, it is envisaged that the first image acquisition device 135 may have different configurations in different embodiments as long as it is capable of collecting light signal and generate image as required, for example, it may not comprise the second iris 130 as shown in FIG. 13; it may not comprise the second iris 130, the tube lens 132 and the dichroic mirror 134 as shown in FIGS. 14 and 15 but may further comprise the emission filter 306.

While it is described in the first embodiment that the stage 118 comprises the standard glass-bottom dish 120, the glass slide 122 and the actuator 126, it is envisaged that the stage 118 may have different configurations in different embodiments as long as it is capable of supporting the biological sample 116 as required, for example, in the third and fourth embodiments depicted in FIGS. 14 and 15, the actuator 126 may not be required when the rotatable scanning mirror 302 can be used to shift an illumination location for scanning; or alternatively both the actuator 126 and the rotatable scanning mirror 302 may be comprised in one embodiment if needed.

While it is described in the first embodiment that the transmission optical device 137 comprises the prism 124 and the second light source 138, it is envisaged that the transmission optical device 137 may have different configurations in different embodiments as long as it is capable of providing transmission light as required, for example, it may comprise the second light source 138, the tube lens 202 and the prism 124 as shown in FIG. 13.

While it is described in the first embodiment that the second image acquisition device 139 comprises the collection objective lens 128, the second iris 130, the tube lens 132, the dichroic mirror 134 and the second camera 140, it is envisaged that the second image acquisition device 139 may have different configurations in different embodiments as long as it is capable of collecting light signal and generate image as required, for example, it may not comprise the second iris 130 as shown in FIG. 13.

While there are advantages of the slanted configuration of the illumination light sheet, it is envisaged that LSH-LSI may have different configuration. For example, in the case of an adequate photon budget, conventional orthogonal detection geometry may be implemented to allow faster depth scanning without using the translational stage 118, i.e. the collection optics is tilted (indicated by a dashed arrow 168 as shown in FIG. 13) to form a right angle with the illumination axis.

While the light source used in the first embodiment is a laser diode with optical output at a centre wavelength of 640 nm, it is envisaged that light sources that generated optical output at other wavelengths may also be used. Similarly, light source different centre wavelength from the green LED may be used for LED 138.

While the stage in the first embodiment is used for mounting a standard glass-bottom dish, it is envisaged that the stage can be configured for mounting other appropriate device suitable for placing a desired biological sample.

While the above described apparatus 100 of the first embodiment and the apparatus 100 of the second embodiment indicate a use of a transmission light path for capturing wide-field images for the ease of sample handling, PIV image analysis, and for providing additional information about the sample, it is envisaged that transmission light path may not be included in the apparatus of a different embodiment.

While it is described in the fourth embodiment that the lens array 404 comprises a cylindrical micro-lens array 404, it is envisaged that the lens array 404 may comprise a cylindrical lens array or other appropriate lens array.

While the biological sample used in the aforementioned description is zebrafish embryos/larvae, it is envisaged that any biological material/body that can scatter light or transmit light may be used as a biological sample. While LSH-LSI is an excellent platform for zebrafish embryos and larvae, it is envisaged that the platform can be adapted to flow imaging for other small animal models, such as mouse and fruit fly larvae, and even further, adapted for medical applications where three-dimensional and quantitative label-free flow imaging is essential (e.g. adapted for in vivo microcirculation imaging of human subjects). Furthermore, the illumination and detection optics can both be shifted above the sample stage to accommodate other animal models that are less transparent.

The high spatial resolution and temporal resolution makes the present invention a perfect imaging solution for a wide range of applications. It is envisaged that the system and method of the present invention can be applied in many areas such as a biomedical research tool for high-quality, non-invasive visualization of microscopic to macroscopic flow with high spatial resolution in three dimensions and high temporal resolution for dynamic flow measurement including medical applications.

1. A laser speckle imaging apparatus for generating flow information of a biological sample, comprising:
an illumination optical device operable to generate one or more illumination light sheets for selectively illuminating the biological sample to produce corresponding scattered light;
a first image acquisition device operable to acquire the corresponding scattered light of each illuminated layer at a same wavelength as the illumination light sheet; and
an image processing device operable to construct 3-dimensional flow information of the biological sample from speckle patterns of the acquired scattered light.

2. The apparatus according to claim 1, wherein the illumination optical device comprises a grating element operable to receive an incident light beam and split the incident light beam into at least two illumination light sheets for selectively illuminating the biological sample at the same time.

3. The apparatus according to claim 2, wherein the grating element comprises a transmission grating.

4. The apparatus according to claim 2, wherein the illumination optical device comprises a cylindrical lens arranged to generate the incident light beam.

5. The apparatus according to claim 2, wherein the incident light beam includes a plurality of incident sub-beams and the illumination optical device comprises a cylindrical lens array arranged to generate the plurality of incident sub-beams for the grating element to split each incident sub-beam into at least two illumination light sheets.

6. The apparatus according to claim 2, wherein the illumination optical device further comprises a rotatable scanning mirror operable to adjust an angular direction of the incident light beam.

7. The apparatus according to claim 6, wherein the rotatable scanning mirror comprises a galvo mirror.

8. The apparatus according to claim 1, wherein an angle between each illumination light sheet propagation direction and the acquired corresponding scattered light's propagation direction is between 30 degrees and 60 degrees.

9. The apparatus according to claim 8, wherein the first image acquisition device further comprises an iris with an adjustable aperture for adjusting the scattered light.

10. (canceled)

11. The apparatus according to claim 1, wherein the first image acquisition device further comprises an emission filter operable to allow desired fluorescence to pass through to the first image acquisition device.

12. The apparatus according to claim 1, further comprising:
a transmission optical device operable to generate an transmission light beam for illuminating the biological sample, the transmission light beam having a different wavelength from the illumination light sheets; and
a second image acquisition device operable to acquire the corresponding transmitted light of the biological sample at a same wavelength as the transmission light beam and generate transmission images,
wherein the image processing device is operable to adjust the constructed 3-dimensional flow information of the biological sample based on transmission images.

13. A laser speckle imaging method, comprising:
generating one or more illumination light sheets to selectively illuminate one or more layers of a biological sample to produce corresponding scattered light;
acquiring the corresponding scattered light at a same wavelength as the illumination light sheet; and
constructing 3-dimensional flow information of the biological sample from speckle patterns of the acquired scattered light.

14. (canceled)

15. (canceled)

16. The method according to claim 13, further comprising adjusting positions of the two or more illumination light sheets to produce another batch of the illuminated layers of the biological sample.

17. The method according to claim 16, wherein the positions of the illuminated layers are adjusted using a galvo mirror.

18. The method according to claim 13, further comprising:
generating a transmission light beam for illuminating the biological sample to produce a transmitted light, the transmission light beam having a different wavelength from the illumination light sheets;
acquiring the transmitted light at a same wavelength as the transmission light beam; and
adjusting the constructed 3-dimensional flow information of the biological sample based on acquired transmitted light.

19. (canceled)

20. Apparatus for imaging a biological sample, comprising:
an illumination optical device comprising
a rotatable scanning mirror operable to adjust an angular direction of an incident light beam to produce a reflected light beam; and
a grating element operable to split the reflected light beam into at least two illumination light sheets for selectively illuminating the biological sample at the same time to produce corresponding light; and
an image acquisition device operable to acquire the corresponding light of each illuminated layer for imaging the biological sample.

21. The apparatus according to claim 20, further comprising an image processing device operable to construct 3-dimensional imaging information of the biological sample from contrasting patterns of the acquired corresponding light.

22. The apparatus according to claim 20, wherein the grating element comprises a transmission grating.

23. (canceled)

24. The apparatus according to claim 20, wherein the incident light beam includes a plurality of incident sub-beams and the illumination optical device comprises a cylindrical lens array arranged to generate the plurality of incident sub-beams for the grating element to split each incident sub-beam into at least two illumination light sheets.

25. (canceled)

26. (canceled)

27. The apparatus according to claim 20, wherein an angle between each illumination light sheet propagation direction and the acquired corresponding light's propagation direction is between 30 degrees and 60 degrees.

28. (canceled)
